(19) United States
(12) Patent Application Publication
(10) Pub. No.: US 2009/0016583 A1
(43) Pub. Date: Jan. 15, 2009

(54) System and Method for Detecting Spherical and Ellipsoidal Objects Using Cutting Planes

(75) Inventors: Matthias Wolf, Coatesville, PA (US); Marcos Salganicoff, Bala Cynwyd, PA (US); Sarang Lakare, Chester Springs, PA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions USA, Inc., Malvern, PA (US)

(21) Appl. No.: 12/169,773

(22) Filed: Jul. 9, 2008

Related U.S. Application Data
(60) Provisional application No. 60/948,756, filed on Jul. 10, 2007.

(51) Int. Cl. G06K 9/46

(52) U.S. Cl. 382/128

(57) ABSTRACT

A method for detecting spherical and ellipsoidal objects is digitized medical images includes providing a 2-dimensional (2D) slice I(x, y) extracted from a medical image volume of a colon, said image volume comprising a plurality of intensities associated with a 3 grid of points, generating a plurality of templates of different sizes whose shape matches a target structure being sought in said slice, calculating a normalized gradient from said slice, calculating a diverging field gradient response (DFGR) for each of the plurality of masks with the normalized gradient, and selecting a strongest response as being indicative of the position and size of the target structure.

### CROSS REFERENCE TO RELATED UNITED STATES APPLICATIONS

This application claims priority from “Using 2D Diverging Gradient Field Response (DGFR) to improve detection of spherical and ellipsoidal objects using cutting planes”, U.S. Provisional Application No. 60/948,756 of Wolf, et al., filed Jul. 10, 2007, the contents of which are herein incorporated by reference in their entirety.

### TECHNICAL FIELD

This disclosure is directed to distinguishing the colon from other structures to improve the detection of spherical and ellipsoidal objects with cutting planes.

### DISCUSSION OF THE RELATED ART

Some image-based computed-aided diagnosis (CAD) tools aim at helping the physician to detect spherical and ellipsoidal structures in a large set of image slices. For the chest, one may be interested in detecting nodules that appear as white spheres or half-spheres inside the dark lung region. In the colon, one may be interested in detecting polyps, which appear as spherical and hemi-spherical protruding structures attached to the colon wall. Similar structures are present in other portions of the anatomy. These could be various types of cysts, polyps in the bladder, hemangiomas in the liver, etc.

Approaches for the detection of spherical or partially spherical structure from 3D images reformulate the task to that of finding circular structures in a number of planes, oriented in a number of directions that span the entire image. Information collected in these planes can afterwards be combined in 3D. Once the task has been reformulated in the context of 2D planes, detection can be expressed as the detection of circular objects, or bumps, in 2D planes. Prior to detection, the image may be pre-processed, for example to enhance the overall outcome of the process, or to find spherical objects in another representation of the same image after a transform.

### SUMMARY OF THE INVENTION

Exemplary embodiments of the invention as described herein generally include methods and systems to analyze partial volume artifacts to differentiate the colon from other structures to improve the detection of spherical and ellipsoidal objects using cutting planes.

According to an aspect of the invention, there is provided a method for detecting spherical and ellipsoidal objects is digitized medical images, including providing a 2-dimensional (2D) slice I(x, y) extracted from a medical image volume of a colon, said image volume comprising a plurality of intensities associated with a 3D grid of points, separating the colon from other structures in the slice by analyzing partial volume artifacts, and finding a target structure in said slice.

According to a further aspect of the invention, separating the colon from other structures comprises generating a plurality of templates of different sizes whose shape matches a target structure being sought in said slice, calculating a normalized gradient from said slice, calculating a diverging field gradient response (DFGR) for each of the plurality of masks with the normalized gradient, and selecting a strongest response as being indicative of the position and size of the target structure.

According to a further aspect of the invention, the 2D slice is extracted from said image volume using a cutting plane.

According to a further aspect of the invention, the structure being sought is a polyp in an image volume of a colon.

According to a further aspect of the invention, calculating a diverging field gradient response comprises calculating

$${\sum }_{j ∈ Ω} {\sum }_{i ∈ Ω} {M}_{x} ( i , j ) {I}_{x} ( x - i , y - j ) + {\sum }_{j ∈ Ω} {\sum }_{i ∈ Ω} {M}_{y} ( i , j ) {I}_{y} ( x - i , y - j ) ,$$

wherein Iₓ and I_{y} are the normalized gradients of slice I(x, y), Mₓ(i,j)=i/\sqrt{i²+j²}, M_{y}(i,j)=j/\sqrt{i²+j²}, is a mask vector of size S, and Ω=[−floor(S/2), floor (S/2)].

According to a further aspect of the invention, the method includes considering each point in said slice and a center and counting a number of points within a given radius of each said center point that fulfill a predetermined selection criteria, providing an accumulator array indexed by center point coordinates and radii values, incrementing an accumulator value by the number of points found to fulfill said criteria, and finding a peak in said accumulator array, wherein the indices of said peak value are indicative of a center and radius of a target structure in said slice.

According to a further aspect of the invention, the method includes selecting a first starting point in said slice, selecting a nearest neighbor point of said starting point having a least intensity value, and selecting said nearest neighbor point as a new starting point, repeating said step of selecting a nearest neighbor point of said starting point having a least intensity value, and selecting said nearest neighbor point as a new starting point until a point with a minimal intensity is reached wherein said selected starting points form a path from said first starting point to said minimal intensity point; and repeating said steps of selecting a first starting point, selecting a nearest neighbor point of said starting point, and repeating said steps for each point in said slice not already on a path of starting points, wherein said paths of starting points define disjoint regions in said slice indicative of structures in said slice.

According to a further aspect of the invention, the method includes calculating a texture feature value for each point in said slice over a window about each point, using said texture feature values to classify points, merging adjacent points with a same classification in to a same region; wherein a region is indicative of structures in said slice.

According to a further aspect of the invention, the texture features are calculated from one of intensity values, color values, or derived image quantities.

According to a further aspect of the invention, the texture features include one or more of Haralick coefficients, co-occurrence matrices, local masks, and moments-based features.

According to another aspect of the invention, there is provided a program storage device readable by a computer, tangibly embodying a program of instructions executable by the computer to perform the method steps for detecting spherical and ellipsoidal objects is digitized medical images.

### BRIEF DESCRIPTION OF THE DRAWINGS

FIG. 1 depicts a cutting plane slice from a 3D computed tomography (CT) image of the colon, presenting a polyp at its center, according to an embodiment of the invention.

FIG. 2 shows a gradient field superimposed on a colon image, according to an embodiment of the invention.

FIG. 3 depicts a detailed view of polyp, according to an embodiment of the invention.

FIG. 4 depicts a gradient fields overlaid with diverging gradient field, according to an embodiment of the invention.

FIG. 5 depicts a response image, according to an embodiment of the invention.

FIG. 6(a)-(b) depict the responses of the original image, according to an embodiment of the invention.

FIG. 7 depicts a response field after applying DGFR to image of FIG. 1, according to an embodiment of the invention.

FIG. 8 is a flowchart of a method for differentiating the colon from other structures to improve detection of spherical and ellipsoidal objects using cutting planes, according to an embodiment of the invention.

FIG. 9 is a block diagram of an exemplary computer system for implementing a method for differentiating the colon from other structures to improve detection of spherical and ellipsoidal objects using cutting planes, according to an embodiment of the invention.

### DETAILED DESCRIPTION OF EXEMPLARY EMBODIMENTS

Exemplary embodiments of the invention as described herein generally include systems and methods to differentiate the colon from other structures to improve detection of spherical and ellipsoidal objects using cutting planes. Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

As used herein, the term “image” refers to multi-dimensional data composed of discrete image elements (e.g., pixels for 2-D images and voxels for 3-D images). The image may be, for example, a medical image of a subject collected by computer tomography, magnetic resonance imaging, ultrasound, or any other medical imaging system known to one of skill in the art. The image may also be provided from non-medical contexts, such as, for example, remote sensing systems, electron microscopy, etc. Although an image can be thought of as a function from R³ to R, the methods of the inventions are not limited to such images, and can be applied to images of any dimension, e.g., a 2-D picture or a 3-D volume. For a 2- or 3-dimensional image, the domain of the image is typically a 2- or 3-dimensional rectangular array, wherein each pixel or voxel can be addressed with reference to a set of 2 or 3 mutually orthogonal axes. The terms “digital” and “digitized” as used herein will refer to images or volumes, as appropriate, in a digital or digitized format acquired via a digital acquisition system or via conversion from an analog image.

Embodiments of the invention are enhancements of approaches disclosed in “Method and system for using cutting planes for colon polyp detection”, U.S. patent application Ser. No. 10/945,310 of Pascal Cathier, filed Sep. 20, 2004, assigned to the assignee of the present invention, the contents of which are herein incorporated by reference in their entirety. Exemplary embodiments of the invention herein presented will be discussed with respect to partially spherical objects in the context of colon polyps in computed tomography (CT) images. However, embodiments of the invention are applicable for a wide range of modalities, including CT, magnetic resonance (MR), ultrasound (US) and positron emission tomography (PET). In addition, image volumes may be obtained as a part of static or dynamic process. Embodiments of the invention may be used to detect holes (depressions), such as diverticulosis, in a symmetrical way.

Cutting planes can be used to locate polyps in a colon CT image, among other applications. Prior to applying cutting planes to the volume, however, the image is preprocessed by applying a simple threshold to distinguish the colon from other structures in the image. In CT images, a simple threshold is sufficient to differentiate between lumen and tissue, but further preprocessing is needed to eliminate other boundaries, such as external air, lung, small intestine, 0 etc. For each voxel in an image volume, the volume is then cut by different planes having different orientations with respect to the axes of the image, each centered on the voxel in question, hereinafter referred to as the central voxel. There is no limitation on the number of orientations that can used, but a set of 9 to 13 cutting planes at different orientations is sufficient. The orientations of these cutting planes should be more or less uniformly distributed on the orientation sphere. The planes should be picked so that the normal to the planes have coordinates (A, B, C), where A, B, C are integers between −1 and 1, subject to the restriction that they cannot all be zero. There are 13 planes that correspond to all possibilities, while 9 planes correspond to the constraint |A|+|B|+|C|<=2.

Since the image has most likely been preprocessed to distinguish the colon from the background, one is interested in examining the trace where the cutting plane intersects the colon. A small and round trace is likely to be part of a polyp, since there are not other small round structures in the colon wall. The appearance of traces defining small and round regions in a set of cutting planes about a voxel is indicative of a polyp. In examining the trace, every voxel is considered exactly once per plane. For each set of plane orientations, there is exactly the correct number of planes so that every voxel in a neighborhood of the central voxel is considered. The choice of 13 plane orientation ensures that all voxels that might be in a polyp are included in one of the cutting planes centered on the central voxel. Those points in a small, round region defined by the trace can be marked as positive after a given plane with a given orientation has been completed for each voxel. Thus, each voxel has a chance to be picked up as a polyp for every plane orientation. If there are 13 plane orientations, each voxel will be cut through by 13 planes, and has 13 chances to become a positive. At the end, a voxel is positive if it has been found positive at any orientation. It is a binary “or” of all plane results. After each voxel has been cut by each of the planes in the set of cutting planes, those points that remain unmarked are discarded from further analysis.

The steps of centering a cutting plane of a given orientation on a given central pixel, examining the trace of the intersection of the cutting plane with the colon, and marking voxels for further analysis are repeated for every voxel in the volume and every cutting plane of a different orientation in the set of cutting planes.

Embodiments of the invention can overcome limitations of the original cutting plane approach, in particular it's sensitivity to a binarization threshold. In an ideal case, a circular object is well separated from the background and from other objects, and thus a simple intensity threshold would be sufficient to isolate regions of interest. However, the separation between the two regions may not be easily accomplished by a simple threshold or by a threshold that can be uniquely applied across an entire image. By skipping the binarization and using intensity values in combination with a 2D transform that takes into account partial volume artifacts, such as the DGFR or Hough transform, this situation can be eliminated.

In particular, a circular object may be close to another object, and the intensity of the other object may actually be close to the intensity of the target object, because of partial volume effect and/or smoothing due to image acquisition and/or reconstruction. Thus, an optimal threshold would have to be able to adapt each object and its adjacent contour to facilitate the separation. Such a threshold must be calculated locally and may vary within a given volume.

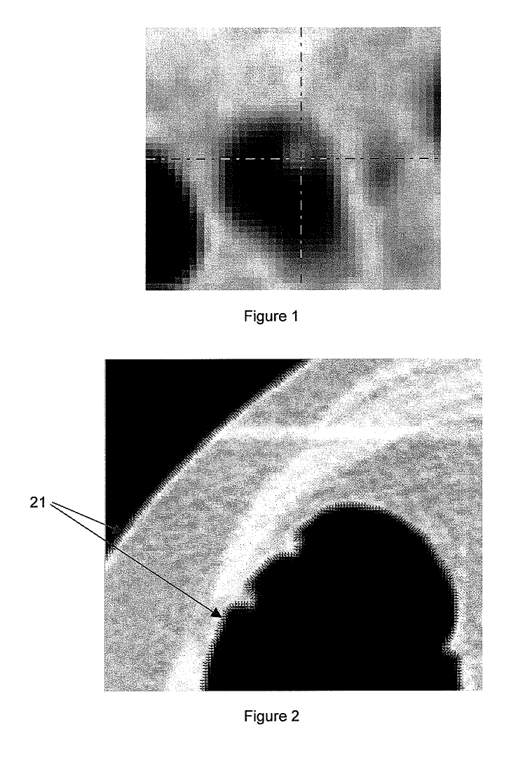

FIG. 1 illustrates this situation on a CT image of the colon. FIG. 1 shows a cutting plane slice from a 3D computed tomography (CT) image of the colon, presenting a polyp at its center. The polyp appears to be connected to the colon wall and will not give an isolated circular region in the center of the image if binarized with too low of a threshold. Note that the intensity between the polyp and the colon differs from the intensity of background, and is in general not predictable.

A method for analyzing partial volume artifacts according to an embodiment of the invention uses DGFR to automatically find circular regions without first segmenting or binarizing the image, and therefore addressing the issue of choosing an optimal threshold. DGFR is only one approach to addressing this situation. Other approaches for detecting circular regions in binary or gray-scale images include Hough-transforms, moment-based methods, gradients, and boundary approaches. These methods will be described in greater detail below.

For simplicity, suppose one wishes to find a perfect solid circle, of radius r in a larger target image. One general approach to detecting objects in an image is to use template matching, in which a template of the object is first chosen or generated, and a correlation between the template and the target image for all possible valid shifts of the template within the target is computed. Then, the peaks of the correlation are selected as candidate positions of the object within the target image. In the case of locating a solid circle of a given radius, one would first generate a solid circle template of the given radius, and perform the template matching. However, it is not hard to see that high correlation peaks could be obtained even by objects within the target that are not circular; for example a solid box.

One way of addressing this situation is to use the edges, as determined by, for example, the magnitude of the gradient, instead. That is, instead of detecting solid circle, one could compute the edges in the image, and then look for a hollow ring.

The diverging gradient field response (DGFR) technique looks for a circle directly in the gradient domain, instead of the edges or magnitude of the gradient as in the case of the previous example. Note that the gradients of a circular structure would appear to be diverging in the case of a circle. A more detailed description of this method is given in “System and method for toboggan based object segmentation using divergent gradient field response in images”, U.S. patent application Ser. No. 11/062,411, of Bogoni, et al., filed Feb. 22, 2005, assigned to the assignee of the present application, the contents of which are herein incorporated by reference in their entirety.

To calculate a DGFR, one first extracts a sub-image volume I(x, y, z) from a location in a raw image volume. The sub-volume can be either isotropic or anisotropic. The sub-image volume broadly covers the candidate object(s) whose presence within the image volume needs to be detected.

When a mask size is compatible with the size of the given polyp, the DGFR technique generates an optimal response. However, the size of the polyp is typically unknown before it has been detected. Hence, DGFR responses need to be computed for multiple mask sizes which results in DGFR responses at multiple scales, where different mask sizes provide the basis for multiples scales.

Next, a normalized gradient field that is independent of intensities in the original image of the sub-volume is calculated for further calculations. A normalized gradient field represents the direction of the gradient, and is estimated by dividing the gradient field by its magnitude.

The computed normalized gradient field is used to calculate DGFR (divergent Gradient Field Response) responses for the normalized gradient field at multiple scales. DGFR response DGFR(x, y, z) is defined as a convolution of the gradient field (Iₓ, I_{y}, I_{z}) with a template vector mask of size S. The template vector field mask is discussed below. The convolution expressed as follows:

$$DGFR ( x , y , z ) = {\sum }_{k ∈ Ω} {\sum }_{j ∈ Ω} {\sum }_{i ∈ Ω} {M}_{x} ( i , j , k ) {I}_{x} ( x - i , y - j , z - k ) + {\sum }_{k ∈ Ω} {\sum }_{j ∈ Ω} {\sum }_{i ∈ Ω} {M}_{y} ( i , j , k ) {I}_{y} ( x - i , y - j , z - k ) + {\sum }_{k ∈ Ω} {\sum }_{j ∈ Ω} {\sum }_{i ∈ Ω} {M}_{z} ( i , j , k ) {I}_{z} ( x - i , y - j , z - k ) ,$$

where the template vector field mask M(Mₓ(x, y, z), M_{y}(x, y, z), M_{z}(x, y, z)) of mask size S is defined as:

Mₓ(i,j,k)=i/\sqrt{i²+j²+k²},

M_{y}(i,j,k)=j/\sqrt{i²+j²+k²},

M_{z}(i,j,k)=k/\sqrt{i²+j²+k²},

with Ω=[−floor(S/2), floor (S/2)].

The convolution above is a vector convolution. While the defined mask M may not be considered to be separable, it can be approximated by single value decomposition and hence a fast implementation of the convolution is achievable. The template vector mask includes the filter coefficients for the DGFR, and is convolved with the gradient vector field to produce the gradient field response. Application of masks of different dimensions, i.e., different convolution kernels, will yield DGFR image responses that emphasize underlying structures where the convolutions give the highest response.

According to an embodiment of the invention, a 2D version of the DGFR method is used, with

$$DGFR ( x , y ) = {\sum }_{j ∈ Ω} {\sum }_{i ∈ Ω} {M}_{x} ( i , j ) {I}_{x} ( x - i , y - j ) + {\sum }_{j ∈ Ω} {\sum }_{i ∈ Ω} {M}_{y} ( i , j ) {I}_{y} ( x - i , y - j ) ,$$

and

Mₓ(i,j)=i/\sqrt{i²+j²},

M_{y}(i,j)=j/\sqrt{i²+j²},

Ω is defined as before. The gradient fields of a circular object will diverge from the center. Circular structures can be found by locating diverging fields in the gradient image. Diverging gradient field responses can be calculated on 2D cutting planes of the 3D input volume.

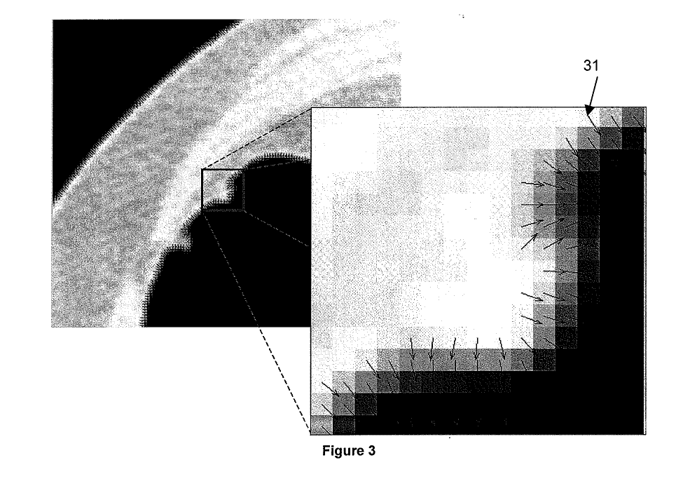

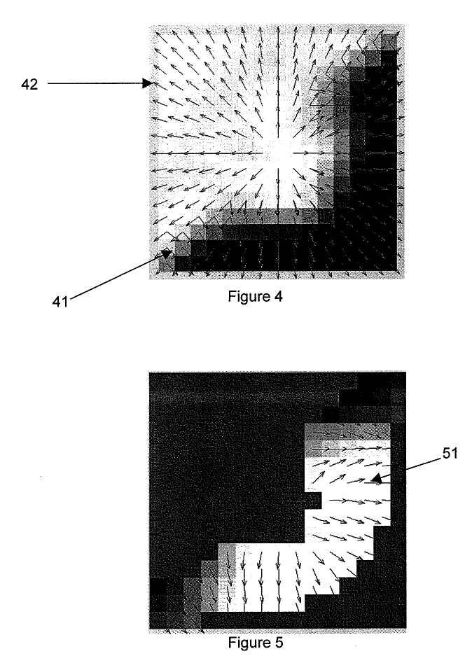

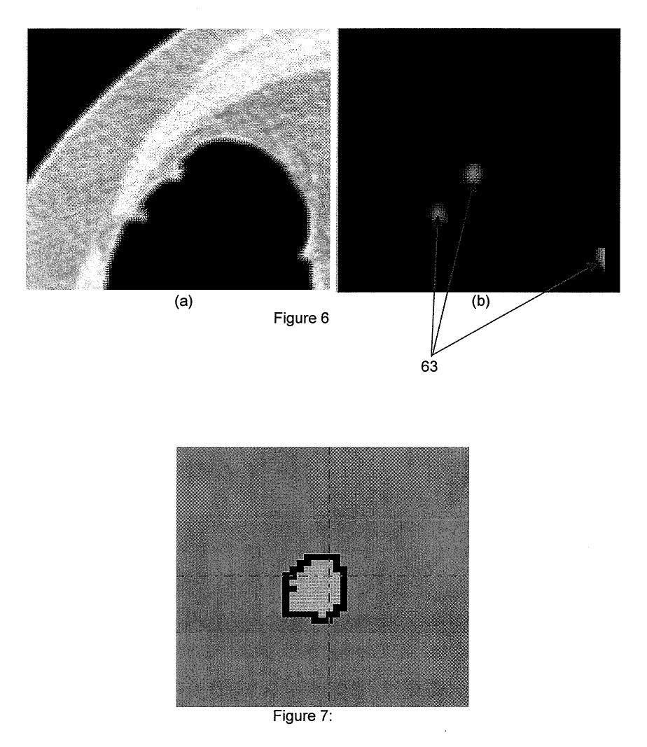

FIG. 2 shows the orientation of a gradient field 21 superimposed at the surface of the colon wall. All gradients point from the brighter tissue to the darker lumen, which is the inside of the colon. FIG. 3 is a zoomed in version of FIG. 2, with the enlarged section shown on the left, with the arrows 31 representing the normalized gradients. The right figure is a detailed view of a polyp that shows the arrows representing the gradient field. FIG. 4 shows an overlay of the diverging gradient field 42 on the normalized gradients 41. This is the template for circular structures of different sizes. This template also defines the expected orientation for each pixel within the template. FIG. 5 shows those pixels where the normalized gradients 51 correspond with the template. The response is calculated based on the magnitude of the gradient and the deviation from the mask at each pixel location. FIGS. 6(a)-(b) depicts those areas 63 with high response in FIG. 6(b) for a given input image in FIG. 6(a).

The DGFR response image of FIG. 1 is presented in FIG. 7. There is a high response at the location of the polyp, separating the polyp from the colon wall without involving a segmentation and addressing the task of estimating a threshold. This separation can then be used for further computation, such as size, shape, etc, based on, for example, connected component algorithms, etc.

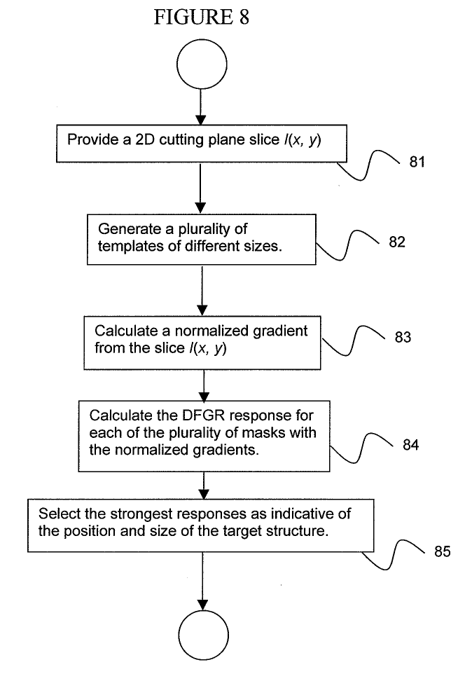

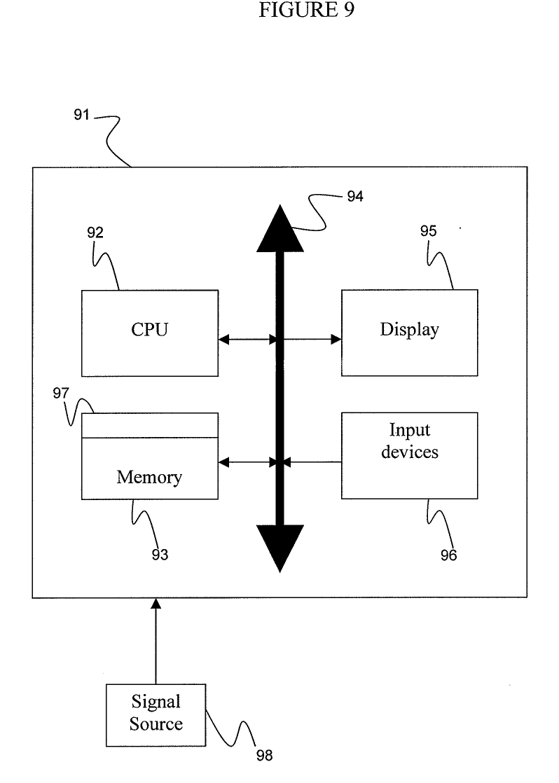

FIG. 8 presents a flowchart of a method for analyzing partial volume artifacts to differentiate the colon from other structures to improve detection of spherical and ellipsoidal objects using cutting planes, according to an embodiment of the invention. The method presented in FIG. 8 uses a DFGR, but this technique is exemplary and non-limiting, and other methods can be used in other embodiments of the invention to analyze partial volume artifacts. Referring now to the figure, a method starts at step 81 by providing a 2D cutting plane slice I(x, y) extracted from an image volume. At step 82, a plurality of templates of different sizes are generated. A normalized gradient Iₓ(x, y), I_{y}(x, y) is calculated from the slice I(x, y) at step 83. At step 84, the DFGR response for each of the plurality of masks with the normalized gradients is calculated. These responses are the correlations between the masks and the target structure being sought in the slice I(x, y). Finally, at step 85, the strongest responses are selected as being indicative of the position and size of the target structure.

As described above, other methods can be used to analyze partial volume artifacts to distinguish the colon from other structures for use with cutting planes.

One such method according to an embodiment of the invention is the Hough transform. The Hough transform is a technique to find imperfect objects, like lines or circles. It is a voting scheme carried out in the parameter space. For circles and spheres, the parameters are the center coordinates and the radius. For ellipsoidal objects, parameters are the foci coordinates and the radii for each axis. Objects are obtained by finding local maxima in a so-called accumulator array. As an example, when using Hough transform for finding circles, the transform is repeatedly computed for all radii in a given search range. Each pixel in the image is considered as the potential center of a circle with a given radius, and the number of pixels lying on the imaginary outline of that given circle are counted. Only pixels from the image/cutting plane that fulfill a given selection criterion are considered. This selection criterion may be the intensity value or a derived value, such as a gradient. That way, all points that lie on the outline of a circle of the given radius contribute to the transform at the center of the circle. Matches between the image and the given radius are summed in the accumulator array. Peaks in the accumulator array indicate the presence of a circle segment of a given radius at a certain position.

Another method according to an embodiment of the invention is the watershed transform. The watershed transform is derived from a topographical concept: watersheds, also called divides, are a ridge of land between two drainage basins. A drop of water falling on the land surface follows the steepest slope until it reaches a regional minimum (basin). When applying this concept to image processing, the intensity values of an image may be considered as altitudes, forming a 3D relief with mountains, ridges, and valleys. When imaginary water drops are falling on this landscape, drops will follow the steepest slopes and collect in drainage basins. When 2 isolated basins are about to merge, a border between both basins is constructed. Those borders form the outline of single regions which partition the image into smaller pieces. Those regions may be used to calculate additional properties that can be used to separate foreground from background, thus giving more accurate intersections with the cutting plane without thresholding the input image first.

Another method according to an embodiment of the invention uses textures and moments. Texture is an important characteristic used in detecting objects or regions of interest. A partition of the input image/cutting plane can also be achieved by calculating texture features around a local window for each pixel in the image and then using those feature values to classify pixels or small regions into different classes. Adjacent pixels/regions with the same class label can then be merged to bigger regions. The final regions may then also be used to calculate additional properties that again can be used to differentiate foreground from background, finally giving more accurate intersections. As texture features, the so-called Haralick coefficients, co-occurrence matrices, local masks, or moment-based features may be used. Texture features are usually calculated from color or intensity values, but may also be calculated on other derived image representation schemes.

It is to be understood that embodiments of the present invention can be implemented in various forms of hardware, software, firmware, special purpose processes, or a combination thereof. In one embodiment, the present invention can be implemented in software as an application program tangible embodied on a computer readable program storage device. The application program can be uploaded to, and executed by, a machine comprising any suitable architecture.

FIG. 9 is a block diagram of an exemplary computer system for implementing a method for distinguishing the colon from other structures to improve detection of spherical and ellipsoidal objects using cutting planes, according to an embodiment of the invention. Referring now to FIG. 9, a computer system 91 for implementing the present invention can comprise, inter alia, a central processing unit (CPU) 92, a memory 93 and an input/output (I/O) interface 94. The computer system 91 is generally coupled through the I/O interface 94 to a display 95 and various input devices 96 such as a mouse and a keyboard. The support circuits can include circuits such as cache, power supplies, clock circuits, and a communication bus. The memory 93 can include random access memory (RAM), read only memory (ROM), disk drive, tape drive, etc., or a combinations thereof. The present invention can be implemented as a routine 97 that is stored in memory 93 and executed by the CPU 92 to process the signal from the signal source 98. As such, the computer system 91 is a general purpose computer system that becomes a specific purpose computer system when executing the routine 97 of the present invention.

The computer system 91 also includes an operating system and micro instruction code. The various processes and functions described herein can either be part of the micro instruction code or part of the application program (or combination thereof) which is executed via the operating system. In addition, various other peripheral devices can be connected to the computer platform such as an additional data storage device and a printing device.

It is to be further understood that, because some of the constituent system components and method steps depicted in the accompanying figures can be implemented in software, the actual connections between the systems components (or the process steps) may differ depending upon the manner in which the present invention is programmed. Given the teachings of the present invention provided herein, one of ordinary skill in the related art will be able to contemplate these and similar implementations or configurations of the present invention.

While the present invention has been described in detail with reference to a preferred embodiment, those skilled in the art will appreciate that various modifications and substitutions can be made thereto without departing from the spirit and scope of the invention as set forth in the appended claims.

What is claimed is:

1. A method for detecting spherical and ellipsoidal objects is digitized medical images comprising the steps of:
providing a 2-dimensional (2D) slice I(x, y) extracted from a medical image volume of a colon, said image volume comprising a plurality of intensities associated with a 3D grid of points;
separating the colon from other structures in the slice by analyzing partial volume artifacts; and
finding a target structure in said slice.

2. The method of claim 1, further comprising:
generating a plurality of templates of different sizes whose shape matches a target structure being sought in said slice;
calculating a normalized gradient from said slice;
calculating a diverging field gradient response (DFGR) for each of the plurality of masks with the normalized gradient; and
selecting a strongest response as being indicative of the position and size of the target structure.

3. The method of claim 1, wherein said 2D slice is extracted from said image volume using a cutting plane.

4. The method of claim 1, wherein said structure being sought is a polyp in an image volume of a colon.

5. The method of claim 2, wherein calculating a diverging field gradient response comprises calculating
$${\sum }_{j ∈ Ω} {\sum }_{i ∈ Ω} {M}_{x} ( i , j ) {I}_{x} ( x - i , y - j ) + {\sum }_{j ∈ Ω} {\sum }_{i ∈ Ω} {M}_{y} ( i , j ) {I}_{y} ( x - i , y - j ) ,$$
wherein Iₓ and I_{y} are the normalized gradients of slice I(x, y), Mₓ(i,j)=i/\sqrt{i²+j²}, M_{y}(i,j)=j/\sqrt{i²+j²}, is a mask vector of size S, and Ω=[−floor(S/2), floor (S/2)].

6. The method of claim 1, The method of claim 1, further comprising:
considering each point in said slice and a center and counting a number of points within a given radius of each said center point that fulfill a predetermined selection criteria;
providing an accumulator array indexed by center point coordinates and radii values;
incrementing an accumulator value by the number of points found to fulfill said criteria; and
finding a peak in said accumulator array, wherein the indices of said peak value are indicative of a center and radius of a target structure in said slice.

7. The method of claim 1, further comprising:
selecting a first starting point in said slice;
selecting a nearest neighbor point of said starting point having a least intensity value, and selecting said nearest neighbor point as a new starting point;
repeating said step of selecting a nearest neighbor point of said starting point having a least intensity value, and selecting said nearest neighbor point as a new starting point until a point with a minimal intensity is reached wherein said selected starting points form a path from said first starting point to said minimal intensity point; and repeating said steps of selecting a first starting point, selecting a nearest neighbor point of said starting point, and repeating said steps for each point in said slice not already on a path of starting points, wherein said paths of starting points define disjoint regions in said slice indicative of structures in said slice.

8. The method of claim 1, further comprising:
calculating a texture feature value for each point in said slice over a window about each point;
using said texture feature values to classify points;
merging adjacent points with a same classification in to a same region; wherein a region is indicative of structures in said slice.

9. The method of claim 8, wherein said texture features are calculated from one of intensity values, color values, or derived image quantities.

10. The method of claim 8, wherein said texture features include one or more of Haralick coefficients, co-occurrence matrices, local masks, and moments-based features.

11. A program storage device readable by a computer, tangibly embodying a program of instructions executable by the computer to perform the method steps for detecting spherical and ellipsoidal objects is digitized medical images, said method comprising the steps of:
providing a 2-dimensional (2D) slice I(x, y) extracted from a medical image volume of a colon, said image volume comprising a plurality of intensities associated with a 3D grid of points;
separating the colon from other structures in the slice by analyzing partial volume artifacts; and
finding a target structure in said slice.

12. The computer readable program storage device of claim 11, the method further comprising:
generating a plurality of templates of different sizes whose shape matches a target structure being sought in said slice;
calculating a normalized gradient from said slice;
calculating a diverging field gradient response (DFGR) for each of the plurality of masks with the normalized gradient; and
selecting a strongest response as being indicative of the position and size of the target structure.

13. The computer readable program storage device of claim 11, wherein said 2D slice is extracted from said image volume using a cutting plane.

14. The computer readable program storage device of claim 11, wherein said structure being sought is a polyp in an image volume of a colon.

15. The computer readable program storage device of claim 12, wherein calculating a diverging field gradient response comprises calculating
$${\sum }_{j ∈ Ω} {\sum }_{i ∈ Ω} {M}_{x} ( i , j ) {I}_{x} ( x - i , y - j ) + {\sum }_{j ∈ Ω} {\sum }_{i ∈ Ω} {M}_{y} ( i , j ) {I}_{y} ( x - i , y - j ) ,$$
wherein Iₓ and I_{y} are the normalized gradients of slice I(x, y), Mₓ(i,j)=i/\sqrt{i²+j²}, M_{y}(i,j)=j/\sqrt{i²+j²}, is a mask vector of size S, and Ω=[−floor(S/2), floor (S/2)].

16. The computer readable program storage device of claim 11, the method further comprising:
considering each point in said slice and a center and counting a number of points within a given radius of each said center point that fulfill a predetermined selection criteria;
providing an accumulator array indexed by center point coordinates and radii values;
incrementing an accumulator value by the number of points found to fulfill said criteria; and
finding a peak in said accumulator array, wherein the indices of said peak value are indicative of a center and radius of a target structure in said slice.

17. The computer readable program storage device of claim 11, the method further comprising:
selecting a first starting point in said slice;
selecting a nearest neighbor point of said starting point having a least intensity value, and selecting said nearest neighbor point as a new starting point;
repeating said step of selecting a nearest neighbor point of said starting point having a least intensity value, and selecting said nearest neighbor point as a new starting point until a point with a minimal intensity is reached wherein said selected starting points form a path from said first starting point to said minimal intensity point; and repeating said steps of selecting a first starting point, selecting a nearest neighbor point of said starting point, and repeating said steps for each point in said slice not already on a path of starting points, wherein said paths of starting points define disjoint regions in said slice indicative of structures in said slice.

18. The computer readable program storage device of claim 11, the method further comprising:
calculating a texture feature value for each point in said slice over a window about each point;
using said texture feature values to classify points;
merging adjacent points with a same classification in to a same region; wherein a region is indicative of structures in said slice.

19. The computer readable program storage device of claim 18, wherein said texture features are calculated from one of intensity values, color values, or derived image quantities.

20. The computer readable program storage device of claim 18, wherein said texture features include one or more of Haralick coefficients, co-occurrence matrices, local masks, and moments-based features.

21. A method for detecting spherical and ellipsoidal objects is digitized medical images comprising the steps of:
providing a 2-dimensional (2D) slice I(x, y) extracted from a medical image volume of a colon, said image volume comprising a plurality of intensities associated with a 3D grid of points;
generating a plurality of templates of different sizes whose shape matches a target structure being sought in said slice;
calculating a normalized gradient from said slice;
calculating a diverging field gradient response (DFGR) for each of the plurality of masks with the normalized gradient; and
selecting a strongest response as being indicative of the position and size of the target structure.

22. The method of claim 21, further comprising separating the colon from other structures in the slice by analyzing partial volume artifacts.
